(19) United States
(12) Patent Application Publication
(10) Pub. No.: US 2004/0186189 A1
(43) Pub. Date: Sep. 23, 2004

(54) Method for producing a plasma-polymerized polymer electrolyte membrane and a polyazol membrane coated by plasma-polymerization

(76) Inventors: Jorg Muller, Buchholz (DE); Laurent Mex, Asendorf (DE)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/482,354

(22) PCT Filed: Jul. 11, 2002
(86) PCT No.: PCT/EP02/07734

(30) Foreign Application Priority Data
Jul. 11, 2001 (DE) 101 33 739.8

(51) Int. Cl. C08J 5/22; H01M 8/10; C25B 13/04

(52) U.S. Cl. 521/27; 429/33; 204/296

(57) ABSTRACT

The invention relates to a method for producing polymer-electrolyte membranes using plasma-assisted deposition in a gaseous phase. Said method simplifies the process in relation to prior art by the selection of its starting materials, carbon or fluorocarbon compounds and water. The invention also relates to a polyazol membrane coated by plasma-polymerization.

The invention relates to a process for producing polymer electrolyte membranes by means of plasma-assisted deposition from the gas phase, which achieves a considerable simplification compared to the prior art by selection of its starting material. Furthermore, the invention relates to a plasma-coated polyazole membrane.

Plasma-polymerized layers have a generally high and also adjustable degree of crosslinking which leads to a high chemical resistance and thermal stability (cf., for example: R. Hartmann: “Plasmapolymodifizierung von Kunststoffoberflächen”, Techn. Rundschau 17 (1988), pages 20-23; A. Brunold et al.: “Modifizierung von Polymeren im Niederdruckplasman, Part 2, mo 51 (1997), pages 81-84). The use of monomers which lead to incorporation of ion-conducting groups (sulfonic acid, phosphonic acid or carboxylic acid groups) in this process makes it possible to produce ion-conducting polymer membranes which, due to their stability and their barrier action in respect of gas or liquid permeation as a result of the high degree of crosslinking, are suitable for use in fuel cells, in particular direct methanol fuel cells, or electrolysis cells. In addition, the deposition technology used makes it possible to produce thin membranes (from a few 10 nm to some 10 μm) which are of interest for, in particular, use in miniaturized fuel cell systems for portable applications (cf., for example: DE 196 24 887 A1, DE 199 14 681 A1) or as barrier layers deposited on conventional membranes (DE 199 14 571 A1), e.g. polybenzimidazole membranes doped with phosphoric acid or membranes containing sulfonic acid groups.

Known plasma-polymerized ion-conducting layers are prepared from various fluorinated hydrocarbons in combination with trifluoromethanesulfonic acid (e.g. DE 195 13 292 .C1, U.S. Pat. No. 5,750,013 A), compounds containing carboxyl groups (DE 196 24 887 A1) or vinylphosphonic acid (DE 199 14 681 A1). When trifluoromethanesulfonic acid is used, fragmentation of the sulfonic acid also occurs in the plasma as a result of the comparable bond energies of the carbon-sulfur bond and the bonds in the sulfonic acid. This results in formation of either highly crosslinked polymers having a very low ion conductivity or polymers having a satisfactory ion conductivity but a low degree of crosslinking and a high proportion of trifluoromethanesulfonic acid which is not covalently bound to the polymer framework and thus electrolytes which do not have long-term stability (cf.: Ber. Bunsenges, Phys. Chem., Vol. 98 (1994), pages 631 to 635). In the case of all the acid compounds mentioned, the plasma polymerization requires vaporization which not only suffers from the disadvantage of the need to handle materials which are hazardous to health but also requires an increased outlay in terms of apparatus.

A significant simplification of the process and a significant reduction in manufacturing costs is offered by plasma polymerization according to the invention of ion-conducting layers using carbon compounds, preferably alkenes and alkynes, or fluorocarbon compounds, preferably fluorinated alkenes, in combination with water. Fragmentation of the water in the plasma leads to formation of OH radicals, as a result of which the carboxyl groups necessary for ion conductivity are formed only during growth of the layer. The use of commercial liquid flow regulators makes it possible to dispense with the vaporizers which are necessary in the case of other acid compounds. The high vapor pressure of water also allows deposition to be carried out at room temperature, while in the case of the acid compounds mentioned, heating of the gas line from the vaporizer to the reactor and of the electrodes is necessary to prevent condensation of acid compounds in these regions.

For use of these novel plasma-polymerized electrolyte membranes in fuel cells, in particular miniaturized fuel cells, they can be produced by combining catalyst layers produced by thin film techniques (e.g. cathode atomization or plasma-assisted deposition from the gas phase) with porous or nonporous conductive contact layers (DE 199 14 681 A). The deposition of these layers can be carried out in a suitable reactor which allows both sputtering processes and deposition from the gas phase, or in separate, connected reactors in each of which one component of the membrane-electrode unit is deposited by a thin film technique and between which transport occurs under reduce pressure. Depending on the substrates used, a stationary deposition process for the plasma-polymerized electrolyte, e.g. for coating individual suitably structured glass or silicon substrates, or a continuous process in the case of a large number of items or when deposition is carried out onto a suitable film can be advantageous.

The process described above is, according to a particular aspect of the present invention, particularly suitable for producing plasma-coated polyazole membranes.

Acid-doped polyazole membranes can be used widely because of their excellent chemical, thermal and mechanical properties and are suitable, in particular, as polymer electrolyte membrane (PEM) in PEM fuel cells.

The basic polyazole membranes are doped with concentrated phosphoric acid or sulfuric acid and act as proton conductors and separators in polymer electrolyte membrane fuel cells (PEM fuel cells).

Due to the excellent properties of polyazole polymers, such polymer electrolyte membranes can, when converting into membrane-electrode units (MEUs), be used in fuel cells at long-term operating temperatures above 100° C., in particular above 120° C. This high long-term operating temperature allows the activity of the catalysts based on noble metals present in the membrane-electrode unit (MEU) to be increased. Particularly when using reforming products from hydrocarbons, significant amounts of carbon monoxide are present in the reformer gas and these usually have to be removed by means of complicated gas work-up or gas purification. Increasing the operating temperature makes it possible for significantly higher concentrations of CO to be tolerated on a long term basis.

Use of polymer electrolyte membranes based on polyazole polymers makes it possible, firstly, to omit the complicated gas work-up or gas purification, at least in part, and, secondly, to reduce the amount of catalyst present in the membrane-electrode unit. Both are indispensable prerequisites for wide use of PEM fuel cells, since otherwise the costs of a PEM fuel cell system are too high.

Polyazoles comprise recurring azole units of the formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII)

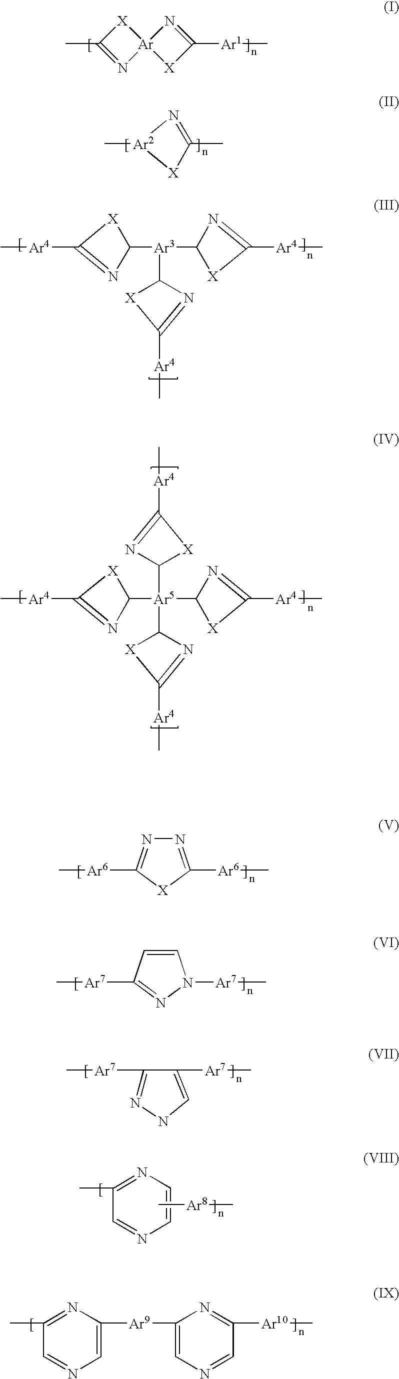

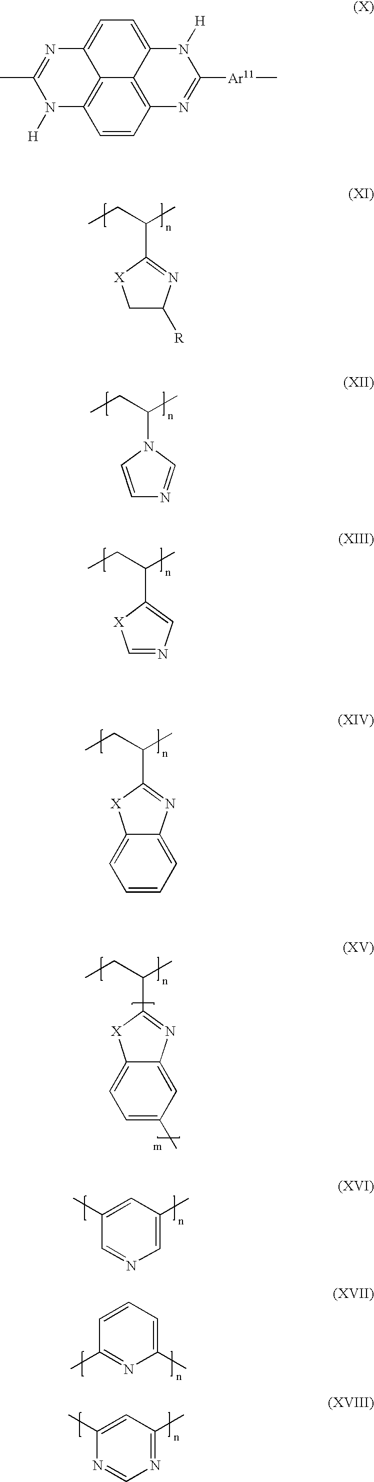

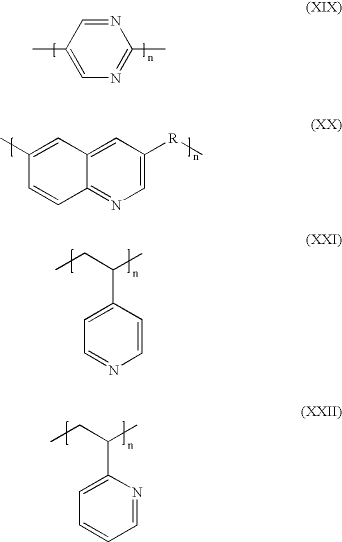

where

Ar are identical or different and are each a tetravalent aromatic or heteroaromatic group which can be monocyclic or polycyclic,

Ar¹ are identical or different and are each a divalent aromatic or heteroaromatic group which can be monocyclic or polycyclic,

Ar² are identical or different and are each a divalent or trivalent aromatic or heteroaromatic group which can be monocyclic or polycyclic,

Ar³ are identical or different and are each a trivalent aromatic or heteroaromatic group which can be monocyclic or polycyclic,

Ar⁴ are identical or different and are each a trivalent aromatic or heteroaromatic group which can be monocyclic or polycyclic,

Ar⁵ are identical or different and are each a tetravalent aromatic or heteroaromatic group which can be monocyclic or polycyclic,

Ar⁶ are identical or different and are each a divalent aromatic or heteroaromatic group which can be monocyclic or polycyclic,

Ar⁷ are identical or different and are each a divalent aromatic or heteroaromatic group which can be monocyclic or polycyclic,

Ar⁸ are identical or different and are each a trivalent aromatic or heteroaromatic group which can be monocyclic or polycyclic,

Ar⁹ are identical or different and are each a divalent or trivalent or tetravalent aromatic or heteroaromatic group which can be monocyclic or polycyclic,

Ar¹⁰ are identical or different and are each a divalent or trivalent aromatic or heteroaromatic group which can be monocyclic or polycyclic,

Ar¹¹ are identical or different and are each a divalent aromatic or heteroaromatic group which can be monocyclic or polycyclic,

X are identical or different and are each oxygen, sulfur or an amino group bearing a hydrogen atom, a group having 1-20 carbon atoms, preferably a branched or unbranched alkyl or alkoxy group, or an aryl group as further radical,

R are identical or different and are each hydrogen, an alkyl group or an aromatic group and

n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrole, pyrazole, anthracene, benzopyrrole, benzotriazole, benzooxathiadiazole, benzooxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, each of which may also be substituted.

Ar¹, Ar⁴, Ar⁶, Ar⁷, Ar⁸, Ar⁹, Ar¹⁰, Ar¹¹ can have any substitution pattern; in the case of phenylene, for example, Ar¹, Ar⁴, Ar⁶, Ar⁷, Ar⁸, Ar⁹, Ar¹⁰, Ar¹¹ can be ortho-, meta- or para-phenylene. Particularly preferred groups are derived from benzene and biphenylene, each of which may also be substituted.

Preferred alkyl groups are short-chain alkyl groups having from 1 to 4 carbon atoms, e.g. methyl, ethyl, n- or i-propyl and t-butyl groups.

Preferred aromatic groups are phenyl or naphthyl groups. The alkyl groups and the aromatic groups may be substituted.

Preferred substituents are halogen atoms such as fluorine, amino groups, hydroxy groups or short-chain alkyl groups such as methyl or ethyl.

Preference is given to polyazoles comprising recurring units of the formula (I) in which the radicals X within a recurring unit are identical.

The polyazoles can in principle also have differing recurring units which, for example, differ in their radical X. However, there are preferably only identical radicals X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In a further embodiment of the present invention, the polymer comprising recurring azole units is a copolymer or a blend comprising at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer comprising recurring azole units is a polyazole containing only units of the formula (I) and/or (II).

The number of recurring azole units in the polymer is preferably greater than or equal to 10. Particularly preferred polymers have at least 100 recurring azole units.

For the purposes of the present invention, preference is given to polymers comprising recurring benzimidazole units. Some examples of extremely advantageous polymers comprising recurring benzimidazole units correspond to the following formulae:

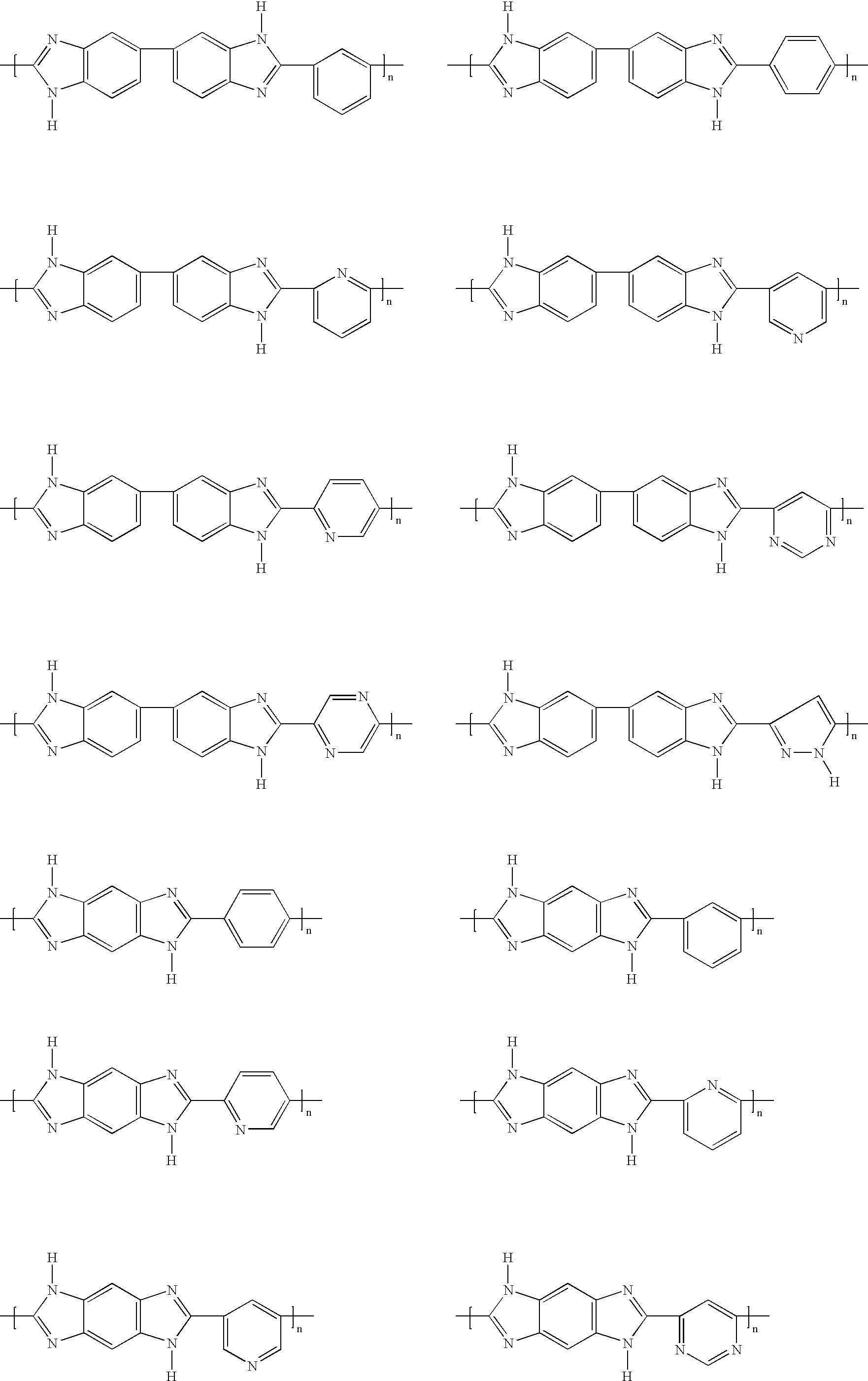

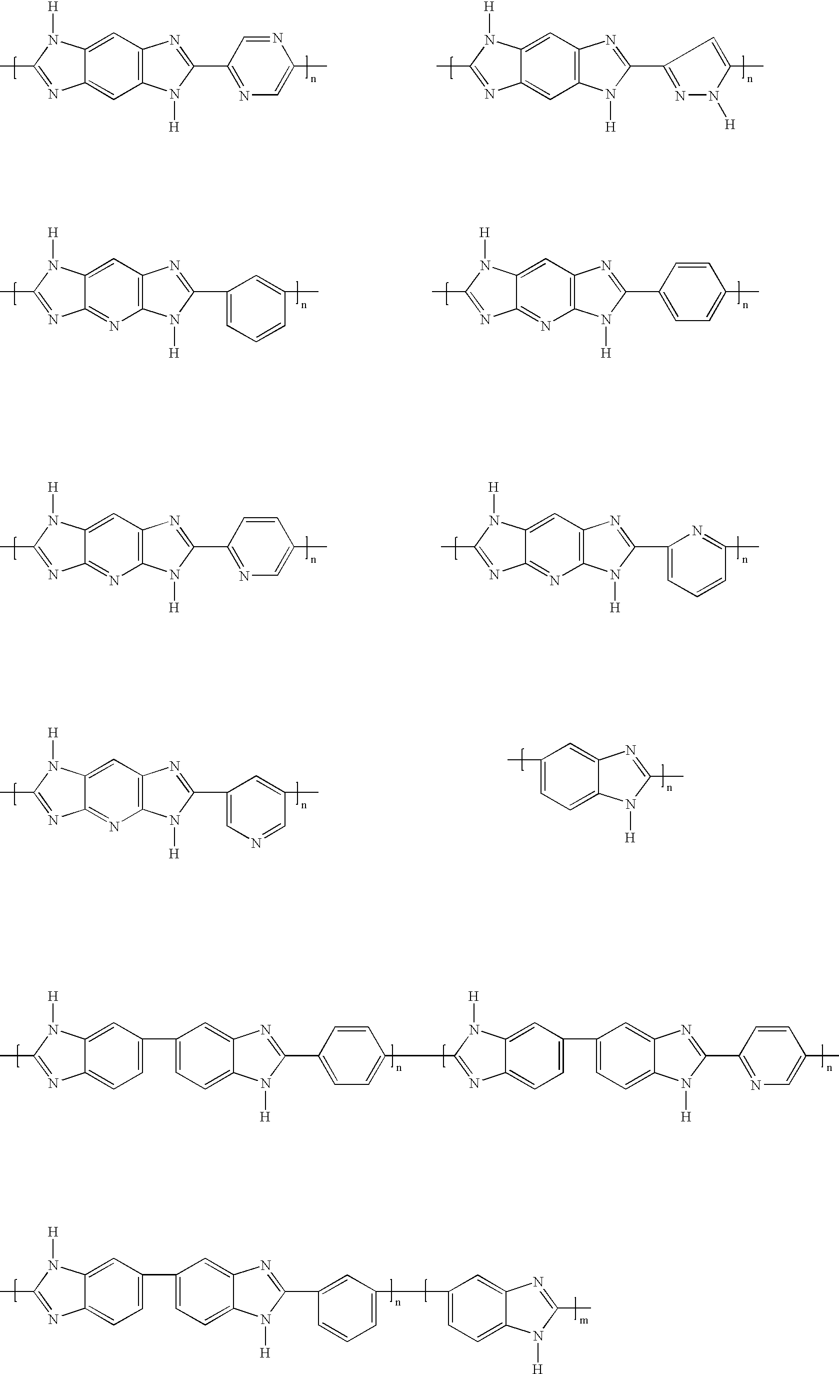

where n and m are each an integer greater than or equal to 10, preferably greater than or equal to 100.

Preferred polyazoles, but in particular the polybenzimidazoles, have a high molecular weight. Measured as intrinsic viscosity, it is at least 1.0 dl/g, preferably at least 1.2 or 1.1 dl/g.

The preparation of such polyazole is known. In the known method, one or more tetraamino compounds is/are reacted with one or more aromatic carboxylic acids or esters thereof which contain at least two acid groups per carboxylic acid monomer in the melt to form a prepolymer. The prepolymer formed solidifies in the reactor and is subsequently comminuted mechanically. The pulverulent prepolymer is usually polymerized fully in a solid-state polymerization at temperatures up to 400° C.

Preferred aromatic carboxylic acids include, inter alia, dicarboxylic acids and tricarboxylic acids and tetracarboxylic acids and their esters or their anhydrides or their acid chlorides. The term aromatic carboxylic acids also encompasses heteroaromatic carboxylic acids.

The aromatic dicarboxylic acids are preferably isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2 6-dihydroxyisophthalic acid, 4,6-dihydroxyisophthalic. acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, bis(4-carboxyphenyl) ether, benzophenone-4,4′-dicarboxylic acid, bis(4-carboxyphenyl) sulfone, biphenyl-4,4′-dicarboxylic acid, 4-trifluoromethylphthalic acid, 2,2-bis(4-carboxyphenyl)hexafluoropropane, 4,4′-stilbenedicarboxylic acid, 4-carboxycinnamic acid, and their C1-C20-alkyl esters or C5-C12-aryl esters, or their acid anhydrides or their acid chlorides.

The aromatic tricarboxylic or tetracarboxylic acids and their C1-C20-alkyl esters or C5-C12-aryl esters or acid anhydrides or acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid, 3,5,4′-biphenyltricarboxylic acid.

The aromatic tetracarboxylic acids and their C1-C20-alkyl esters or C5-C12-aryl esters or acid anhydrides or acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid, 1,4,5,8-naphthalenetetracarboxylic acid.

The heteroaromatic carboxylic acids used are preferably heteroaromatic dicarboxylic acids and tricarboxylic acids and tetracarboxylic acids or their esters or anhydrides. For the purposes of the present invention, heteroaromatic carboxylic acids are aromatic systems containing at least one nitrogen, oxygen, sulfur or phosphorus atom in the aromatic. Preference is given to pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinecarboxylic acid, 3,5-pyrazoledicarboxylic acid, 2,6-pyrimidinedicarboxylic acid, 2,5-pyrazinedicarboxylic acid, 2,4,6-pyridinetricarboxylic acid, benzimidazole5,6-dicarboxylic acid, and also their C1-C20-alkyl esters or C5-C12-aryl esters or their acid anhydrides or their acid chlorides.

The content of tricarboxylic acid or tetracarboxylic acids (based on dicarboxylic acid used) is in the range from 0 to 30 mol %, preferably from 0.1 to 20 mol %, in particular from 0.5 to 10 mol %.

The aromatic and heteroaromatic diaminocarboxylic acids used are preferably diaminobenzoic acid an its monohydrochloride and dihydrochloride derivatives.

Preference is given to using mixtures of at least 2 different aromatic carboxylic acids. Particular preference is given to using mixtures comprising both aromatic carboxylic acids and heteroaromatic carboxylic acids. The mixing ratio of aromatic carboxylic acids to heteroaromatic carboxylic acids is in the range from 1:99 to 99:1, preferably from 1:50 to 50:1.

These mixtures are, in particular, mixtures of N-heteroaromatic dicarboxylic acids and aromatic dicarboxylic acids. Nonlimiting examples are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyophthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, bis(4-carboxyphenyl) ether, benzophenone-4,4,-dicarboxylic acid, bis(4-carboxyphenyl) sulfone, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinecarboxylic acid, 3,5-pyrazoledicarboxylic acid, 2,6-pyrimidinedicarboxylic acid, 2,5-pyrazinedicarboxylic acid.

Preferred aromatic tetraamino compounds include, inter alia, 3,3′,4,4′-tetraaminobiphenyl, 2,3,5,6-tetraaminopyridine, 1,2,4,5-tetraaminobenzene, bis(3,4-diaminophenyl) sulfone, bis(3,4-diaminophenyl) ether, 3,3′,4,4′-tetraaminobenzophenone, 3,3′,4,4′-tetraaminodiphenylmethane and 3,3′,4,4,-tetraaminodiphenyldimethylmethane and also their salts, in particular their monohydrochloride, dihydrochloride, trihydrochloride and tetrahydrochloride derivatives.

Preferred polybenzimidazoles are commercially available under the trade name ®Celazole from Celanese AG.

Apart from the abovementioned polymers, it is also possible to use a blend which further comprises additional polymers. The blend component essentially has the task of improving the mechanical properties and reducing the cost of materials. A preferred blend component is polyether sulfone, as described in the German patent application No. 10052242.4.

To produce polymer films, the polyazole is, in a further step, dissolved in polar, aprotic solvents such as dimethylacetamide (DMAc) and a film is produced by classical methods.

To remove residual solvent, the film obtained in this way can be treated with a washing liquid. This washing liquid is preferably selected from the group consisting of alcohols, ketones, alkanes (aliphatic and cycloaliphatic), ethers (aliphatic and cycloaliphatic), esters, carboxylic acids, each of which may be halogenated, water, inorganic acids (e.g. H₃PO₄, H₂SO₄) and mixtures thereof.

In particulars C1-C₁₀-alcohols, C₂-C₅-ketones, C1-C₁₀-alkanes (aliphatic and cycloaliphatic), C₂-C₆-ethers (aliphatic and cycloaliphatic), C₂-C₅-esters, C₁-C₃-carboxylic acids, dichloromethane, water, inorganic acids (e.g. H₃PO₄, H₂SO₄) and mixtures thereof are used. Among these liquids., particular preference is given to water.

After washing, the film can be dried to remove the washing liquid. The drying conditions depend on the partial vapor pressure of the treatment liquid chosen. Drying is usually carried out at atmospheric pressure and temperatures of from 20° C. to 200° C. More gentle drying can also be carried out under reduced pressure. In place of drying, the membrane can also be dabbed free of excess treatment liquid. The order is not critical.

The above-described removal of residual solvent from the polyazole film surprisingly results in an improvement in the mechanical properties of the film. These properties include, in particular, the modulus of elasticity, the ultimate tensile strength and the fracture toughness of the film.

In addition, the polymer film can have been modified in other ways, for example by crosslinking as described in the German patent application No 10110752.8 or in WO 00/44816. In a preferred embodiment, the polymer film used comprises not only a basic polymer and at least one blend component but also a crosslinker as described in the German patent application No. 10140147.7.

Instead of the polymer films produced by classical methods, it is also possible to use the polyazole-containing polymer membranes described in the German patent applications No. 10117686.4, 10144815.5, 10117687.2.

The thickness of the polyazole films can vary within a wide range. The thickness of the polyazole film prior to doping with acid is preferably in the range from 5 μm to 2000 μm, particularly preferably from 10 μm to 1000 μm, without this implying a restriction.

To make the films proton-conducting, they are doped with an acid. In this context, the term “acid” encompasses all known Lewis and Brnsted acids, preferably inorganic Lewis and Brnsted acids.

Furthermore, it is also possible to use polyacids, in particular isopolyacids and heteropolyacids, and also mixtures of various acids. For the purposes of the present invention, heteropolyacids are inorganic polyacids which have a least two different central atoms and are formed as partial mixed anhydrides from weak, polybasic oxo acids of a metal (preferably Cr, Mo, V, W) and a nonmetal (preferably As, I, P, Se, Te). They include, inter alia, 12-molybdophosphoric acid and 12-tungstophosphoric acid.

The conductivity of the polyazole film can be influenced via the degree of doping. The conductivity increases with increasing concentration of -dopant until a maximum value has been reached. According to the invention, the degree of doping is reported as mol of acid per mol of repeating units of the polymer. For the purposes of the present invention, a degree of doping of from 3 to 30, in particular from 5 to 18, is preferred.

Particularly preferred dopants are sulfuric acid and phosphoric acid. A very particularly preferred dopant is phosphoric acid (H₃PO₄). In general, use is made of highly concentrated acids. According to a particular aspect of the present invention, the concentration of phosphoric acid is at least 50% by weight, in particular at least 80% by weight, based on the weight of the dopant.

Furthermore, doped polyazole films can also be obtained by a process comprising the steps

I) dissolution of the polyazole polymer in polyphosphoric acid,

II) heating of the solution obtainable by the method of step A) under inert gas to temperatures of up to 400° C.,

III) formation of a membrane using the solution of the polyazole polymer from step II) on a support and

IV) treatment of the membrane formed in step III) until it is self-supporting.

Furthermore, doped polyazole films can be obtained by a process comprising the steps

A) mixing of one or more aromatic tetraamino compounds with one or more aromatic carboxylic acids or esters thereof which contain at least two acid groups per carboxylic acid monomer, or mixing of one or more aromatic and/or heteroaromatic diaminocarboxylic acids, in polyphosphoric acid to form a solution and/or dispersion,

B) application of a layer to a support or to an electrode using the mixture from step A),

C) heating of the flat structure/layer obtainable by the method of step B) to temperatures of up to 350° C., preferably up to 280° C., under inert gas to form the polyazole polymer,

D) treatment of the membrane formed in step C) (until it is self-supporting).

The aromatic or heteroaromatic carboxylic acids and tetraamino compounds to be used in step A) have been described above.

The polyphosphoric acid used in step A) is commercial polyphosphoric acid as is obtainable from, for example, Riedel-de Haen. The polyphosphoric acids Hₙ₊₂PₙO₃ₙ₊₁ (n>1) usually have a P₂O₅ content (determined acidimetrically) of at least 83%. Instead of a solution of the monomers, it is also possible to produce a dispersion/suspension. The mixture produced in step A) has a weight ratio of polyphosphoric acid to the sum of all monomers from 1:10 000 to 10 000:1, preferably from 1:1000 to 1000:1, in particular from 1:100 to 100:1.

Layer formation as per step B) is carried out by methods which are known per se from the prior art in the field of polymer film production (casting, spraying, doctor blade coating). As supports, it is possible to use all supports which are inert under the conditions in question. To adjust the viscosity, the solution can, if appropriate, be admixed with phosphoric acid (conc. phosphoric acid, 85%). In this way, the viscosity can be set to the desired value and the formation of the membrane can be made easier.

The layer produced in step B) has a thickness of from 20 to 4000 μm, preferably from 30 to 3500 μm, in particular from 50 to 3000 μm.

If the mixture produced in step A) further comprises tricarboxylic acids or tetracarboxylic acids, this results in branching/crosslinking of the polymer formed. This contributes to an improvement in the mechanical properties. The polymer layer produced in step C) is treated in the presence of moisture at temperatures and for a time sufficient for the layer to have sufficient strength for use in fuel cells. The treatment can be carried out for such a time that the membrane is self-supporting and can be detached from the support without damage.

The inert gases to be used in step C) are known to those skilled in the art. They include, in particular, nitrogen and noble gases such as neon, argon, helium.

In a variant of the process, the mixture from step A) can be heated to temperatures of up to 350° C., preferably up to 280° C., to effect formation of oligomers and/or polymers. Depending on the temperature and time selected, the heating in step C) can subsequently be partly or entirely omitted. This variant, too, is subject matter of the present invention.

The treatment of the membrane in step D) is carried out at temperatures above 0C and less than 150° C., preferably at temperatures in the range from 10° C. to 120° C., in particular from room temperature (20° C.) to 90° C., in the presence of moisture or water and/or water vapor and/or water-containing phosphoric acid having a concentration up to 85%. The treatment is preferably carried out under superatmospheric pressure, but can also be carried out under superatmospheric pressure. It is important that the treatment occurs in the presence of sufficient moisture, so that the polyphosphoric acid present is partially hydrolyzed to form low molecular weight polyphosphoric acid and/or phosphoric acid and thus contributes to strengthening of the membrane.

The partial hydrolysis of the polyphosphoric acid in step D) leads to strengthening of the membrane and to a decrease in the layer thickness and formation of a membrane having a thickness of from 15 to 3000 μm, preferably from 20 to 2000 μm, in particular from 20 to 1500 μm, which is self-supporting. The intramolecular and intermolecular structures (interpenetrating networks IPN) present in the polyphosphoric acid layer from step B) lead, in step C), to ordered membrane formation which is responsible for the particular properties of the membrane formed.

The upper temperature limit of the treatment in step D) is generally 150° C. When moisture, for example superheated steam, acts on the membrane for an extremely short time, this steam can also be hotter than 150° C. The upper temperature limit is linked to the duration of the treatment.

The partial hydrolysis (step D) can also be carried out in temperature- and humidity-controlled chambers in which the hydrolysis can be controlled in the presence of a defined amount of moisture. Here, the humidity can be set in a targeted manner via the temperature or by saturation of the environment with which the membrane is in contact, for example gases such as air, nitrogen, carbon dioxide or other suitable gases, or water vapor. The treatment time is dependent on the parameters selected above.

Furthermore, the treatment time depends on the thickness of the membrane.

The treatment time is generally from a few seconds to minutes, for example in the presence of superheated steam, or up to a number of days, for example in air at room temperature and low relative atmospheric humidity. The treatment time is preferably in the range from 10 seconds to 300 hours, in particular from 1 minute to 200 hours.

If the partial hydrolysis is carried out at room temperature (20° C.) using ambient air having a relative atmospheric humidity of 40-80%, the treatment time is from 1 to 200 hours.

The membrane obtained as per step D) can be made self-supporting, i.e. it can be detached from the support without damage and subsequently be directly processed further, if desired.

The concentration of phosphoric acid and thus the conductivity of the polymer membrane can be adjusted via the degree of hydrolysis, i.e. the time, temperature and ambient-humidity. The concentration of phosphoric acid is reported as mol of acid per mol of repeating units in the polymer. The process comprising the steps A) to D) makes it possible to obtain membranes having a particularly high phosphoric acid concentration. Preference is given to a concentration (mol of phosphoric acid per repeating unit of the formula (I), for example polybenzimidazole) of from 10 to 50, in particular from 12 to 40. Such high degrees of doping (concentrations) can be achieved only with great difficulty, if at all, by doping polyazoles with commercially available ortho-phosphoric acid.

Subsequent to the treatment as per step D), the membrane can be crosslinked further on the surface by action of heat in the presence of atmospheric oxygen. This hardening of the membrane surface effects an additional improvement in the properties of the membrane.

The crosslinking can also be carried out by action of IR or NIR (IR=infrared, i.e. light having a wavelength of more than 700 nm; NIR=near IR, i.e. light having a wavelength in the range from about 700 to 2000 nm or an energy in the range from about 0.6 to 1.75 eV). A further method is irradiation with β-rays. The radiation; dose is in this case in the range from 5 to 200 kGy.

In a modification of the process described, in which doped polyazole films are produced by use of polyphosphoric acid, these films can also be produced by a process comprising the steps

1) reaction of one or more aromatic tetraamino compounds with one or more aromatic carboxylic acids or esters thereof containing at least two acid groups per carboxylic acid monomer, or of one or more aromatic and/or heteroaromatic diaminocarboxylic acids, in the melt at temperatures of up to 350° C., preferably up to 300° C.,

2) dissolution of the solid prepolymer obtained in step 1) in polyphosphoric acid,

3) heating of the solution obtainable by the method of step 2) to temperatures of up to 300° C., preferably up to 280° C., under inert gas to form the dissolved polyazole polymer,

4) formation of a membrane on a support using the solution of the polyazole polymer from step 3) and

5) treatment of the membrane formed in step 4) until it is self-supporting.

The process steps presented under points 1) to 5) have been described in detail above for steps A) to D), which are, in particular in respect of preferred embodiments, incorporated by reference at this point.

The polyazole film can be provided with a plasma-polymerized ion-conducting layer before or after doping with acid. However, the plasma polymerization is preferably carried out after doping.

The polyazole film can be provided with a layer according to the invention which is a plasma-polymerized ion-conducting electrolyte membrane. This layer prevents washing-out of acid, so that this layer can also be referred to as a barrier layer.

It has been found that it is advantageous for the barrier layer to be located on the cathode side of the polymer electrolyte membrane, since the overvoltage is significantly reduced.

Furthermore, it is also possible for both sides of the polyazole film to be provided with a layer according to the invention. This gives a sandwich-like structure in which the polyazole film which may be doped with acid forms the middle layer while the layers obtainable by the plasma process of the invention are located on the outside.

The way in which plasma polymerization is carried out is known to those skilled in the art and is disclosed, for example, in the abovementioned documents. Information on carrying out plasma polymerization may also be found in Ullmann's Encyclopedia of Industrial Chemistry, on CDROM, 5th Ed., keyword Plastics, Processing, Coating Processes, and in Boing, H., Plasma Science and Technology, Carl Hanser Verlag, Munich 1982.

For the purposes of the present invention, the term plasma refers to a partially ionized gas. A plasma can be produced by excitation of a gas by means of electromagnetic radiations. The irradiation can be either continuous or pulsed. Furthermore, DC or AC voltage sources can be used for generating the plasma. Apparatuses for generating plasmas can be obtained commercially from, for example, GaLa Gabler Labor Instrumente GmbH.

The plasma polymerization can, depending on the method, be carried out at a pressure of from 0.001 to 1000 Pa, preferably from 0.1 to 100 Pa and particularly preferably from 1 to 50 Pa. The temperature during plasma coating is preferably in the range from 0° to 300°, more preferably from 5 to 250° C., without this constituting a restriction.

The precursors used for plasma coating comprise water plus a matrix-forming component. The matrix-forming component comprises, in particular, unsaturated organic compounds. These include, inter alia, alkenes, in particular ethylene, propylene, 1-hexene, 1-heptene, vinylcyclohexane, 3,3-dimethyl-1-propene, 3-methyl-1-diisobutylene, 4-methyl-1-pentene;

alkynes, in particular ethyne, propyne, butyne, 1-hexyne;

vinyl compounds containing an acid group, in particular vinylphosphonic acid, vinylsulfonic acid, acrylic acid and methacrylic acid;

vinyl compounds containing a basic group, in particular vinylpyridine, 3-vinylpyridine, 2-methyl-5-vinylpyridine, 3-ethyl-4-vinylpyridine, 2,3-dimethyl-5-vinylpyridine, N-vinylpyrrolidone, 2-vinylpyrrolidone, N-vinylpyrrolidine and 3-vinylpyrrolidine; fluorinated alkenes, in particular monofluoroethylene, difluoroethylene, trifluoroethylene, tetrafluoroethylene, hexafluoropropylene, pentafluoropropylene, trifluoropropylene, hexafluoroisobutylene, trifluorovinylsulfonic acid, trifluorovinylphosphonic acid and perfluoro(vinyl methyl ether).

The abovementioned compounds can be used individually or as mixtures.

The proportion of matrix-forming component is generally from 1 to 99% by weight, preferably from 50 to 99% by weight, particularly preferably from 60 to 99% by weight, based on the gas mixture used for plasma coating.

The proportion of water is generally from 1 to 99% by weight, preferably from 1 to 50% by weight, particularly preferably from 1 to 40% by weight, based on the gas mixture used for plasma coating.

The gas mixture can further comprise an inert carrier gas. Such gases include, for example, noble gases such as helium and neon.

The constituents of the gas mixture used for plasma polymerization can be mixed prior to introduction into the coating chamber. As an alternative, the various compounds can also be introduced separately into the chamber.

The treatment time can vary within a wide range. The polyazole film, which may be doped, is preferably coated under plasma conditions for from 10 seconds to 10 hours, preferably from 1 minute to 1 hour.

The flow rates of the gases into the vacuum chamber, the energy used for generating the plasma and further process parameters can vary within wide ranges, and the parameters customary for the process employed can be chosen. Information on such parameters can generally be found in the operating instructions for the respective apparatuses.

Preferred processes for producing a coating according to the invention include both plasma polymerization with continuous introduction of power and the plasma impulse chemical vapor deposition process (PICVD).

The PICVD process is described, for example, in Journal of the Ceramic Society of Japan, 99 (10), 894-902 (1991), and the coating of curved surfaces has also been disclosed (cf. WO 95/26427).

In PICVD processes, the electromagnetic radiation which excites the plasma is generally applied in pulses while the coating gases flow continuously through the coating chamber, so that a thin layer (typically about 1 nm, monolayer region) is deposited on the substrate on each impulse. Each power impulse is followed by a pause, so that high coating rates can be achieved without appreciable thermal stressing of the substrate. The amplitude and duration of the power impulses and the duration of the pause between impulses are particularly critical for the production of a layer. In a PICVD process, the impulse amplitude is a measure of the power. It corresponds to the pulse power, i.e. the product of generator voltage and generator current during the impulse. The proportion of the power which actually goes into the plasma depends on a number of parameters, e.g. the dimensions of the impulse-radiating component and the reactor.

Depending on the impulse amplitude,

a) various excitations and reactions are generated in the plasma above a threshold value which is characteristic for each gas,

b) various thicknesses of the plasma zone are set.

When using the PICVD process, elemental layers (monolayers) of different composition can be deposited from impulse to impulse by means of appropriate selection of the impulse amplitude. This is achieved, in particular, by appropriate selection of the pause between impulses, so that the same gas composition is present on each, impulse, for example by means of clean separation of the offgas from the fresh gas. Similar results are not possible when using conventional PCVD processes.

The following ranges of the power parameters are particularly preferred:

| | |
|---|---|
| Impulse duration: | from 0.01 to 10 milliseconds, |
| | in particular from 0.1 to 2 |
| | milliseconds; |
| Pause between impulses: | from 1 to 1000 milliseconds, |
| | in particular from 5 to 500 |
| | milliseconds; and |
| Impulse amplitude: | from 10 to 100 000 watt. |

The PICVD process, is carried out using AC voltage impulses having a frequency of from 50 kHz and 300 gigahertz, with frequencies from 13.56 MHz and 2.45 GHz being particularly preferred.

The flow rate of the gas in the PICVD process is generally selected so that the gas can be regarded as static during the impulse. Accordingly, the mass flows are generally in the range from 1 to 200 standard cm³/minute, preferably in the range from 5 to 100 standard cm³/minute.

The intrinsic conductivity of the plasma-polymerized ion-conducting layer is, depending on the mixing ratio of the matrix-forming component and the water in the plasma, in the range from 0.001 S/cm to 0.3 S/cm at 80° C., without this constituting a restriction. The determination of these values is carried out in a simple manner by means of impedance spectroscopy, with the plasma-polymerized layers being deposited on a dielectric support onto which two or four electrodes, depending on the measurement technique, preferably platinum or gold electrodes deposited using the thin film technique, have previously been applied. A temperature-dependent measurement of the conductivity is carried out by heating the specimen, e.g. by means of a hotplate with temperature regulation via a temperature sensor which is positioned in the immediate vicinity of the layer to be measured, or by heating the specimen in a suitable measurement cell in an oven.

Owing to the process by which they are produced and the resulting high degree of crosslinking, the plasma-polymerized ion-conducting layers have a high stability. Aging and stability tests can be carried out, for example, by heating in a temperature range from 100° C. to 500° C., with examination of the structure of the plasma-polymerized layers, e.g. by means of infrared spectroscopy, allowing conclusions to be drawn regarding the structural changes occurring as a result of heating and thus regarding the stability of these layers.

The polyazole membranes provided with a layer obtainable by plasma polymerization display a surprisingly high conductivity over a wide temperature range. Thus, the membranes obtainable according to the invention display a surprisingly high conductivity both at low temperatures in the range from 0° C. to 50° C. and at high temperatures above 120° C.

According to a particular aspect of the present invention, the polyazole membranes which have been provided with a layer obtainable by plasma polymerization and have been doped with an acid have a high conductivity of at least 0.005 S/cm, in particular at least 0.01 S/cm, particularly preferably at least 0.02 S/cm, at 120° C., without this constituting a restriction. These values are determined using impedance spectroscopy.

The specific conductivity can be measured by means of impedance spectroscopy in a 4-pole arrangement in the potentiostatic mode using platinum electrodes (wire, 0.25 mm diameter). The distance between the current-collecting electrodes is 2 cm. The spectrum obtained is evaluated by means of a simple model consisting of a parallel arrangement of an ohmic resistance and a capacitance. The specimen cross section of the membrane doped with phosphoric acid is measured immediately before mounting of the specimen. To measure the temperature dependence, the measurement cell is brought to the desired temperature in an oven and the temperature is regulated via a Pt-100 resistances thermometer positioned in the immediate vicinity of the specimen. After the temperature has been reached, the specimen is kept at this temperature for 10 minutes before commencement of the measurement.

Furthermore, the acid present in the polyazole film is kept in the film astonishingly well by means of the coating according to the invention, so that the acid is not washed out in operation at low temperatures.

Measurement of the barrier action of a layer obtained according to the invention by plasma polymerization in the case of, for example, membranes doped with phosphoric acid can be carried out as follows:

The barrier action is measured in a simple manner via the change in the pH of water as a function of time. This is carried out using a measurement cell comprising two chambers which are separated by a plasma-polymerized layer according to the invention. The water to be measured and a pH electrode are located in one chamber, while a solution, preferably phosphoric acid solution, of known concentration or a polyazole membrane doped with phosphoric acid in direct contact with the plasma-polymerized layer is placed in the other chamber.

To separate the two chambers, the plasma-polymerized layer according to the invention is advantageously deposited on a porous support, e.g. a porous film or a porous ceramic. This coated support is placed in a suitable holder which separates the two chambers of the measurement cell and leaves a defined surface region of the plasma-polymerized layer on the support accessible on both sides.

In addition, a polyazole membrane which has been coated according to the invention and doped with an acid displays a very low overvoltage. This property is retained even over a long period of operation and many start-up cycles.

Furthermore, the polyazole membranes provided with a costing according to the invention display a surprisingly high durability which is observed in operation both at low temperatures and high temperatures.

The present invention also provides a membrane-electrode unit comprising at least one polyazole-based polymer membrane according to the invention.

Further information on membrane-electrode units may be found in the specialist literature, in particular the patents U.S. Pat. No. 4,191,618, U.S. Pat. No. 4,212,714 and U.S. Pat. No. 4,333,805. The disclosure regarding the structure and the production of membrane-electrode units and also the electrodes, gas diffusion layers and catalysts to be selected in the abovementioned references [U.S. Pat. No. 4,191,618, U.S. Pat. No. 4,212,714 and U.S. Pat. No. 4,333,805] is hereby incorporated by reference into the present description.

In a further variant, a catalytically active layer can be applied to the membrane of the invention and this can be joined to a gas diffusion layer.

The present invention likewise provides a membrane-electrode unit comprising at least one polymer membrane according to the invention, if desired in combination with a further polymer membrane based on polyazoles or a polymer blend membrane.

An advantage of MEUs comprising polyazole membranes is that they make it possible for the fuel cell to be operated at temperatures above 120° C. This applies to fuel cells using gaseous and liquid fuels, e.g. hydrogen-containing gases which are prepared, for example, from hydrocarbons in an upstream reforming step. As oxidant, it is possible to use, for example, oxygen or air.

A further advantage of the MEUs comprising the polyazoles membranes is that in operation above 120° C., even when using pure platinum catalyst, i.e. without a further alloy constituent, they display a high tolerance toward carbon monoxide. At a temperature of 160° C., for example, more than 1% of CO can be present in the fuel gas without this leading to an appreciable reduction in the performance of the,fuel cell.

The MEUs comprising doped polyazole films can be employed in fuel cells without the fuel gases and the oxidants having to be humidified, despite the high operating temperatures which are possible. The fuel cells nevertheless operate in a stable fashion and the membrane does not loose its conductivity. This simplifies the entire fuel cell system and brings additional cost savings, since the water circuit is simplified. Moreover, this also improves the behavior of the fuel cell system at temperatures below 0° C.

The MEUs comprising a doped polyazole film surprisingly allow the fuel cell to be cooled to room temperature and below without problems and then be taken back into operation without the performance deteriorating. In contrast, conventional fuel cells based on phosphoric acid always have to be maintained at a temperature above 80° C. even when the fuel cell system is shut down so as to avoid irreversible damage.

Furthermore, the MEUs comprising a polyazole membrane have a very high long-term stability. It has been found that a fuel cell according to the invention can be operated continuously for long periods, e.g. for more than 1000 hours, preferably more than 2000 hours and particularly preferably more than 5000 hours, at temperatures above 120° C. using dry reaction gases, without an appreciable deterioration in performance being observed. The power densities achievable under these conditions remain very high even after such a long time.

1. A process for producing a plasma-polymerized ion-conducting electrolyte membrane, characterized in that it is produced by means of plasma-assisted copolymerization of a matrix-forming component, preferably hydrogen compounds or fluorinated hydrocarbon compounds, and water.

2. The process for producing a plasma-polymerized ion-conducting electrolyte membrane as claimed in claim 1, characterized in that precursors used for the matrix-forming component are fluorinated alkenes, preferably tetrafluoroethylene.

3. The process for producing a plasma-polymerized ion-conducting electrolyte membrane as claimed in claim 1, characterized in that precursors used for the matrix-forming component are alkenes, preferably ethylene.

4. The process for producing a plasma-polymerized ion-conducting electrolyte membrane as claimed in claim 1, characterized in that precursors used for the matrix-forming component are alkynes, preferably acetylene.

5. The process for producing a plasma-polymerized ion-conducting electrolyte membrane as claimed in one or more of claims 1 to 4, characterized in that the layers are deposited in a parallel-plate plasma reactor.

6. The process for producing a plasma-polymerized ion-conducting electrolyte membrane as claimed in any of claims 1 to 5, characterized in that coating is carried out with the substrate stationary.

7. The process for producing a plasma-polymerized ion-conducting electrolyte membrane as claimed in any of claims 1 to 5, characterized in that coating is carried out in a process in which the substrate passes through the coating chamber.

8. The use of plasma-polymerized ion-conducting electrolyte membranes produced as claimed in one or more of claims 1 to 7 in a fuel cell.

9. The use of plasma-polymerized ion-conducting electrolyte membranes produced as claimed in one or more of claims 1 to 7 as thin barrier layer to prevent gas or liquid permeation on a polymer electrolyte membrane which has not been produced by means of plasma polymerization.

10. The use of plasma-polymerized ion-conducting electrolyte membranes produced as claimed in one or more of claims 1 to 7 in an electrolysis cell.

11. A plasma-coated polyazole membrane, characterized in that a polyazole film is coated with a plasma-polymerized ion-conducting layer obtainable by a process as claimed in any of claims 1 to 7.

12. A polyazole membrane as claimed in claim 11, characterized in that the polyazole film is doped with an acid.

13. A polyazole membrane as claimed in claim 12, characterized in that the degree of doping is from 3 to 15.

14. A polyazole membrane as claimed in any of claims 11 to 13, characterized in that the plasma-polymerized ion-conducting layer has a thickness in the range from 10 mm to 20 μm.

15. A polyazole membrane as claimed in any of claims 11 to 14, characterized in that the polyazole film comprises polymers comprising recurring azole units of the formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVI) and/or (XVII) and/or (XVIII) and/or (XIX) and/or (XX) and/or (XXI) and/or (XXII) 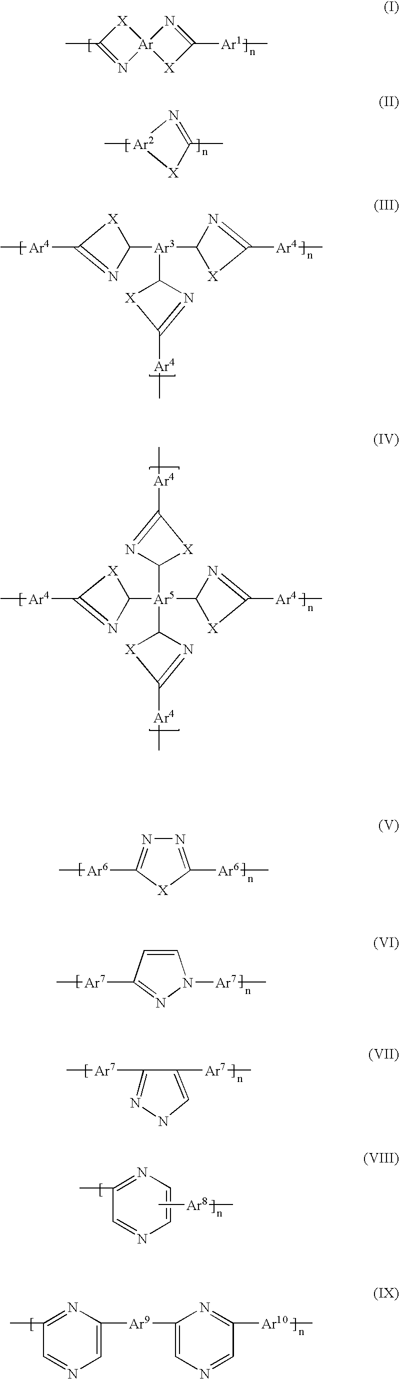 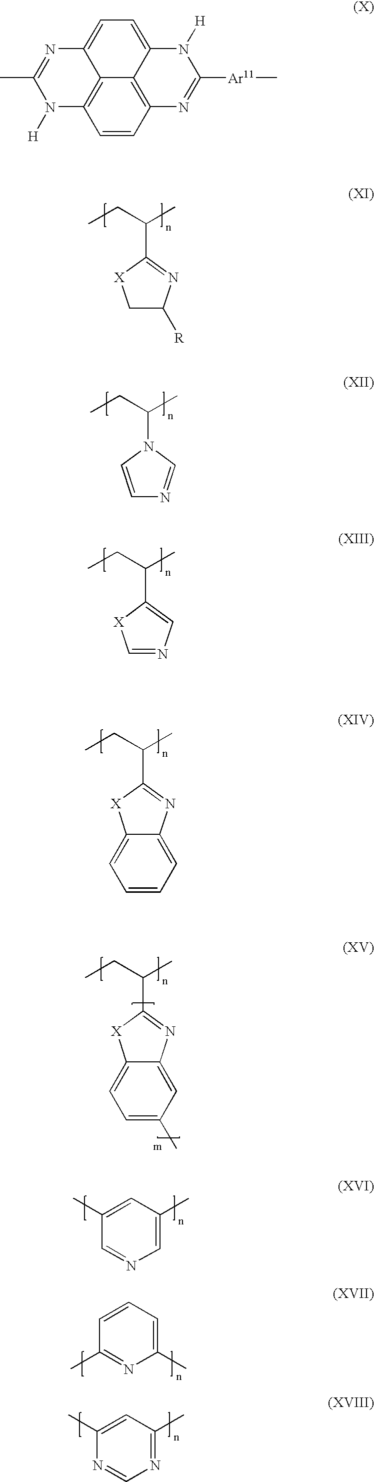 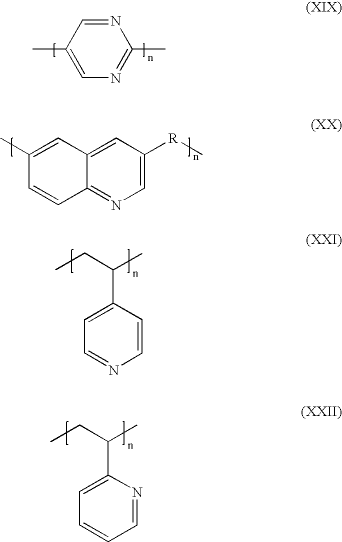
where
Ar are identical or different and are each a tetravalent aromatic or heteroaromatic group which can be monocyclic or polycyclic,
Ar¹ are identical or different and are each a divalent aromatic or heteroaromatic group which can be monocyclic or polycyclic,
Ar² are identical or different and are each a divalent or trivalent aromatic or heteroaromatic group which can be monocyclic or polycyclic,
Ar³ are identical or different and are each a trivalent aromatic or heteroaromatic group which can be monocyclic or polycyclic,
Ar⁴ are identical or different and are each a trivalent aromatic or heteroaromatic group which can be monocyclic or polycyclic,
Ar⁵ are identical or different and are each a tetravalent aromatic or heteroaromatic group which can be monocyclic or polycyclic,
Ar⁶ are identical or different and are each a divalent aromatic or heteroaromatic group which can be monocyclic or polycyclic,
Ar⁷ are identical or different and are each a divalent aromatic or heteroaromatic group which can be monocyclic or polycyclic,
Ar⁸ are identical or different and are each a trivalent aromatic or heteroaromatic group which can be monocyclic or polycyclic,
Ar⁹ are identical or different and are each a divalent or trivalent or tetravalent aromatic or heteroaromatic group which can be monocyclic or polycyclic,
Ar¹⁰ are identical or different and are each a divalent or trivalent aromatic or heteroaromatic group which can be monocyclic or polycyclic,
Ar¹¹ are identical or different and are each a divalent aromatic or heteroaromatic group which can be monocyclic or polycyclic,
X are identical or different and are each oxygen, sulfur or an amino group bearing a hydrogen atom, a group having 1-20 carbon atoms, preferably a branched or unbranched alkyl or alkoxy group, or an aryl group as further radical,
R are identical or different and are each hydrogen, an alkyl group or an aromatic group and
n, m are each an integer greater than or equal to 10, preferably greater than or equal to 100.

16. A polyazole member as claimed in any of claims 11 to 15, characterized in that the polyazole film comprises polymers selected from the group consisting of polybenzimidazole, poly(pyridines), poly(pyrimidines), polyimidazoles, polybenzothiazoles, polybenzoxazoles, polyoxadiazoles, polyquinoxalines, polythiadiazoles, and poly(tetrazapyrenes).

17. A polyazole membrane as claimed in any of claims 12 to 16, characterized in that the polyazole film is obtainable by a process comprising the steps
A) dissolution of the polyazole polymer in polyphosphoric acid,
B) heating of the solution obtainable by the method of step A) under inert gas to temperatures of up to 400° C.,
C) formation of a membrane using the solution of the polyazole polymer from step B) on a support and
D) treatment of the membrane formed in step C) until it is self-supporting.

18. A membrane-electrode unit comprising at least one plasma-coated polyazole membrane as claimed in any of claims 11 to 16.
